(19) United States
(12) Patent Application Publication
(10) Pub. No.: US 2005/0280961 A1
(43) Pub. Date: Dec. 22, 2005

(54) Leakage current detection interrupter with sensor module for detecting abnormal non-electrical conditions

(76) Inventor: Steve Campolo, Malverne, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 10/871,436

(22) Filed: Jun. 18, 2004

(51) Int. Cl. H02H 3/00

(52) U.S. Cl. 361/42

(57) ABSTRACT

In the present invention the basic detection and interruption components of a Leakage Current Detector Interrupter (LCDI) in combination with a sensor module are coupled to a conductor such as a shield conductor of an extension or appliance cord having line, neutral, possibly ground and shield conductors to provide a new improved type of detector which interrupts current to a load when an abnormal non-electrical condition such as smoke, high heat, high or low pressure, etc. is detected by the sensor module. The sensor module in combination with the LCDI provides, either singularly or in combination, the following advantages: A sensor module that need not be rated to carry the full electrical load required by the appliance because the LCDI can operate with a nominal low current signal; Prevents the LCDI from being reset should the device become inoperative (reset lockout); Tests the integrity of the conductor from the sensor module within the extension or appliance cord, in addition to testing the functionality of the LCDI; and, Can interrupt current to the load if an electrical connection is detected between the sensor module conductor and neutral, or the sensor module conductor and ground.

### BACKGROUND OF THE INVENTION

1. Field of the Invention

This invention is directed generally to a power supply cord having a circuit for interrupting power to a load and, more specifically, to a power supply cord having a Leakage Current Detection Interrupter and sensor module which interrupts power to a load when an abnormal non-electrical condition is detected.

2. Description of the Prior Art

The electrical extension cord in use today includes a plug, usually comprising two or three prongs, an electrical conducting cord typically comprising two or three insulated wires several feet in length and a terminal connector or receptacle for receiving one or more electrical plugs to power lamps, a television, household appliances, an air conditioner, etc. A grounded extension cord includes a plug having three prongs and a three conductor insulated wire cord where two conductors are utilized for phase and neutral or return power and the third conductor is used as a common ground. While extension cords provide many advantages, there are some disadvantages that are also associated with their use. For example, extension cords are often left underneath rugs where they are trampled upon, or they are pinched by doors and furniture which can lead to arcing or short circuiting which can cause a fire. Extension cords also frequently tend to be left coiled where heat can concentrate, or are overloaded to the point of destruction by fire. In other situations the extension cord, or a power supply cord is connected to an appliance or an electrical device such as a fan, room air conditioner, refrigerator, etc., which can develop a high heat condition, or generates a smoke condition, etc. Given the number of dangerous situations which can develop with electrical appliance use, such as residential fires, high heat condition, smoke, etc., an extension or power cord which can detect and interrupt the flow of power to an appliance when an abnormal non-electrical condition occurs is desired.

U.S. Pat. No. 5,642,248 assigned to Leviton Manufacturing Co., Inc. discloses an electrical extension cord where the insulated phase, neutral and ground conductors are surrounded by a braided sensing shield. The braided shield is electrically connected at the receptacle to the ground conductor and extends to the plug. Leakage current released from the conductors can be collected in the shield and detected by a Ground Fault Circuit Interrupter (GFCI) to interrupt the flow of current to the load. The purpose of the shield is to capture any type of leakage current within the extension cord and transfer it to ground such that the GFCI may detect the current imbalance and interrupt the circuit. This type of device is commonly known as a Leakage Current Detector Interrupter (LCDI).

Present day GFCI based leakage current detectors have several limitations. One such limitation is that of being a relatively expensive and complex device which requires the use of one or more toroidal transformers to function. These transformers can be very large for high current applications. In addition, presently available devices require that a ground be available at the outlet that the leakage current detector is plugged into. This may not always be the case in residential circuits, and some applications, such as in hospitals which require a floating ground.

Another problem inherent in circuit interrupting devices that can be plugged into household outlets and used for detecting an abnormal non-electrical condition such as a high heat condition, smoke, etc., is that the sensing element is normally designed to send a current which is large enough to operate a relay connected to interrupt the power to the load

What is needed is an appliance power cord such as an extension cord which, when connected to supply power to an appliance such as an air conditioner, fan, washing machine, refrigerator, etc., will interrupt the flow of current to the appliance with a small nominal value of current when an abnormal non-electrical condition such as smoke, high heat, etc., is detected.

### SUMMARY OF THE INVENTION

In the present invention the basic detection and interruption components of a Leakage Current Detector Interrupter (LCDI) in combination with a sensor module are coupled to a conductor such as a wire or a shield conductor of an extension or appliance power cord having line, neutral and shield conductors to provide a new improved type of detector which interrupts current to a load when an abnormal non-electrical condition such as smoke, high heat, high or low pressure, etc. is detected by the sensor module. The sensor module in combination with the LCDI provides, either singularly or in combination, the following advantages: A sensor module that need not be rated to carry the full electrical load required by the appliance because the LCDI can operate with a nominal low current signal; Prevents the LCDI from being reset should the device become inoperative (reset lockout); Tests the integrity of the conductor from the sensor module within the extension or appliance cord, in addition to testing the functionality of the LCDI; and, Can interrupt current to the load if an electrical connection is detected between the sensor module conductor and neutral, or the sensor module conductor and ground.

The foregoing has outlined, rather broadly, a preferred blending feature, for example, of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a bases for designing or modifying other structures for carrying out the same purposes of the present invention and that such other structures do not depart from the spirit and scope of the invention in its broadest form.

### BRIEF DESCRIPTION OF THE DRAWING

Other aspects, features, and advantages of the present invention will become more fully apparent from the following detailed description, the appended claim, and the accompanying drawings in which similar elements are given similar reference numerals.

FIG. 1 is a diagram of a prior art circuit commonly known as an IDCI located in a plug and connected to spaced apart conductors located in a hand held appliance such as a hair dryer to provide shock hazard protection for water related shock hazard conditions;

FIG. 2 is a diagram of an IDCI circuit with reset lockout, load power indication and voltage surge protection;

FIG. 3 is a diagram of an LCDI circuit located in the plug of a cord in combination with a sensor module is accordance with the principles of the invention;

FIG. 4 is a schematic of an LCDI circuit located in the plug of a cord having an integrity indicator and sensor module coupled to the other end of said cord;

FIG. 5 is a schematic of an LCDI circuit, sensor module and integrity indicator located in the plug of a cord;

FIG. 6 is a schematic of an LCDI circuit, sensor module and integrity indicator located in the plug and having a return wire in the cord;

FIG. 7 is a schematic of an LCDI circuit located in the plug of a cord and having a shield integrity test switch and sensor module at the other end of the cord;

FIG. 8 is a schematic of an LCDI circuit, sensor module and integrity test switch located in the plug of a cord; and,

FIG. 9 is a sectional view of a flat shielded cord.

### DETAILED DESCRIPTION OF THE PREFERRED EMBODIMENT

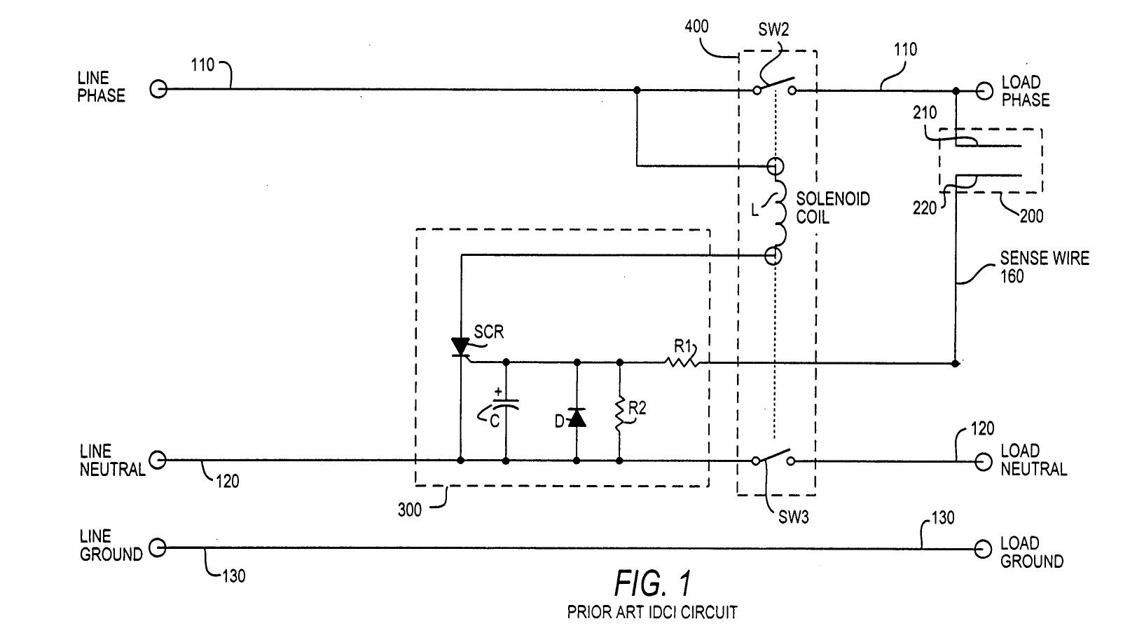

Referring to FIG. 1, there is illustrated a schematic diagram of a prior art Immersion Detection Circuit Interrupter (IDCI) circuit which provides shock hazard protection for water related shock hazard conditions within small electrical appliances connected to an AC source of 110-120 volts such as, for example, a hand held hair dryer as disclosed in U.S. Pat. No. 6,016,244 assigned to Leviton Manufacturing Co., Inc., and which is incorporated herein by reference in its entirety. In FIG. 1, electrical conductors 110, 120 are respectively connected to an AC source. A pair of hazard or immersion detection conductors 210, 220 are positioned in non-contacting relationship within the device that is to be protected such as the hair dryer. The conductors are preferably located in proximity to a port of the appliance to be protected where water can enter.

One end of immersion detection conductor 210 is operatively connected to the phase conductor of an AC source via electrical conductor 110, and one end of the second immersion detection conductors 220 is connected to the sense wire 160 which can be a single wire which runs substantially parallel with but insulated from the other wires in the cord. The other ends of the immersion detection conductors 210, 220 are unconnected and maintained in a spaced apart relationship. Immersion of conductors 210, 220 in water creates a conductive path between the two conductors. Control circuit 300 comprises a solid state switching control circuit and includes a first resistor R1 connected between the gate of a Silicon Controlled Rectifier (SCR) and the sense wire 160. Resistor R1 limits the current applied to the gate of the SCR. The control circuit 300 includes a parallel network comprising resistor R2, capacitor C and diode D connected between the gate and cathode terminals of the SCR. These components provide a measure of noise immunity and protection against damage across the gate to cathode junction of the SCR.

Interrupter circuit 400 comprises an electrical circuit for interrupting the flow of current and includes a solenoid coil L, a first switch SW2 connected in series with conductor 110 and a second switch SW3 in series with conductor 120. Switches SW2 and SW3 are mechanically latched closed but are also responsive to the flow of current through solenoid coil L and are closed when such current is not flowing. In response to the flow of such current, SW2 and SW3 switch from the normally closed position to the shock hazard condition open position. When current flows through solenoid coil L, its magnetic field moves a plunger which unlatches SW2 and SW3. The cathode terminal of the SCR is connected to electrical conductor 120.

The immersion of both unconnected ends of the pair of immersion detection conductors 210, 220 into water causes the electrical AC source to be connected to the gate of the SCR via the path provided by electrical conductor 110, immersion detection conductor 210, the electrically conducting path provided by the water in which the unconnected ends of the immersion detection conductors 210, 220 are immersed, immersion detection conductor 220, electrical conductor 160, and resistor R1. In response thereto, the SCR switches from the normally non-conducting state to the shock hazard condition conducting state, thereby providing a path for current to flow through solenoid coil L to cause switches SW2 and SW3 to switch from the normally closed position to the shock hazard condition open position and thus operatively disconnect the AC source from the electrical appliance.

Electrical conductors 110, 120 and 130 comprise a three wire conductor having an AC source compatible plug at the source end, the control circuit 300 and interrupter circuit 400 contained in the plug, and the detector 200 contained in the hand held hair drier. Exemplary values for the circuit illustrated in FIG. 1 are as follows: R1 is 2000 ohms, R2 is 1000 ohms, C is 0.1 microfarads, D is IN4004 and the SCR is 2N5064.

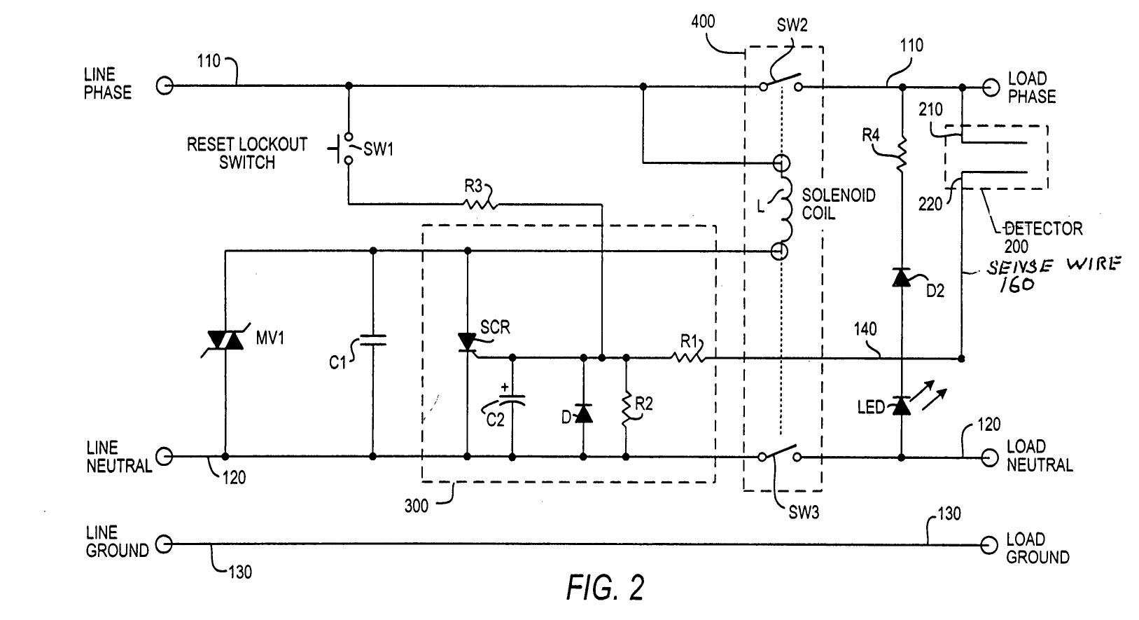

FIG. 2 is a schematic diagram of an Immersion detection circuit Interrupter in combination with additional circuitry to provide the features of reset lockout, load power indication and voltage surge protection.

Reset lockout protection is provided through switch SW1 and resistor R3. Switch SW1 is normally open and closes when switches SW2 and SW3 are in the shock hazard open position and the reset button of the IDCI is pressed. Current is supplied to the gate of the SCR through resistor R3. This causes the SCR to conduct allowing current through the solenoid coil L. Firing the solenoid coil removes an impediment from the path of the reset button opening SW1 once more and allows switches SW2 and SW3 to close. This mechanism is described in more detail in U.S. patent Pub. No. 20020003686 entitled IDCI With Reset Lockout And Independent Trip assigned to Leviton Manufacturing Co., Inc., and which is incorporated herein in its entirety by reference. The reset lockout function prevents SW2 and SW3 from being closed (reset) to supply power to the load if the IDCI is non-functional or if an open neutral condition exists.

Load power indication is provided by an LED, supplied with rectified current by diode D2 and resistor R4, and utilizing load phase conductor 110 and load neutral conductor 120 as a power source. When the plug containing the IDCI is connected to a wall outlet and switches SW2 and SW3 are closed, the LED is illuminated. If SW2 and SW3 are open, or the IDCI is unplugged, the LED is extinguished. Added protection from voltage surges on the AC line is provided by capacitor C1 and metal oxide varistor MV1.

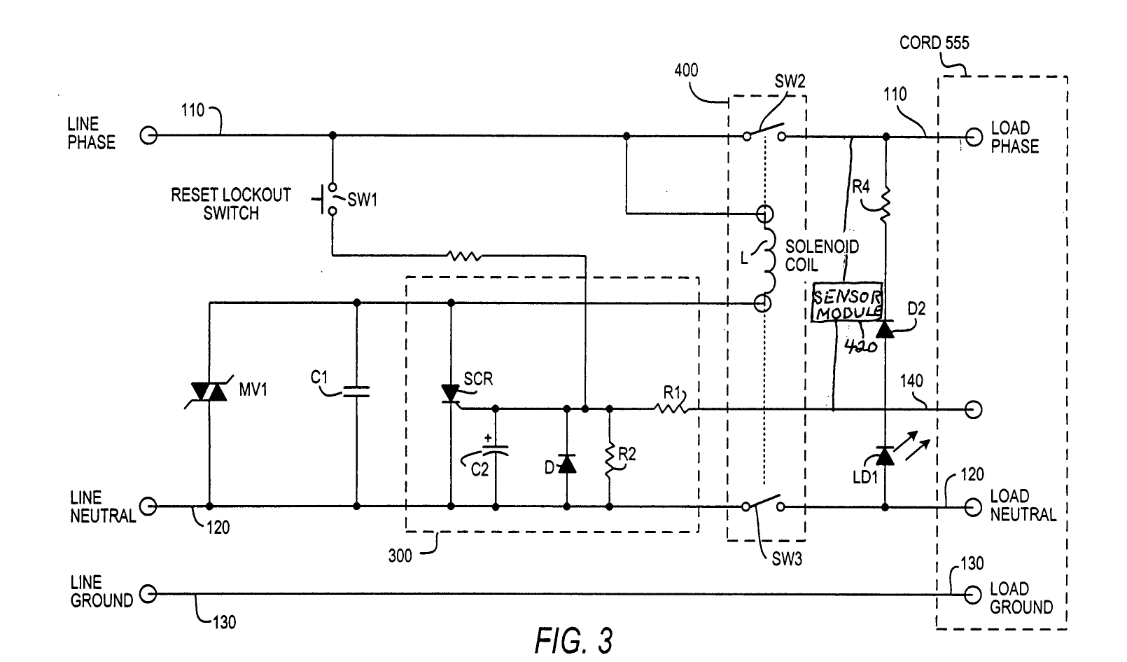

Referring to FIG. 3, there is shown a schematic diagram of an LCDI with reset lockout. The schematic of FIG. 3 is similar to that of FIG. 2 except that the sense wire 160 is replaced by a conductive shield 140, the detector 200 is eliminated and a sensor module 420 is connected between the load phase and shield. The sensor module is used to detect an abnormal non-electric condition such as overheating of an appliance, a smoke condition, a high heat condition, a high or low water condition, etc.

In each embodiment of the invention here disclosed and illustrated in the FIGS. subsequent to FIG. 2, the electrical conductor 140 is a conductive shield which surrounds the various conductors of the cord. It is to be understood, however, that the term conductive shield as used here after comprises either a single wire which runs substantially parallel with but insulated from the other wires in the cord, a shield which surrounds the various conductors in the extension cord, or one or more wires in substantially parallel relationship with the other wires in the cord, or one or more wires which surround the various wires in the extension cord or the equivalent.

It is to be noted that the positioning of the shield relative to the conductors can be within a flat power cord and can take various configurations which allows the circuit to be used to detect very low levels of current such as leakage current. When a low level of current is detected, switches SW2 and SW3 open and power is removed from the cord. In this way a low level or nominal value of current is used to cause the power to be interrupted.

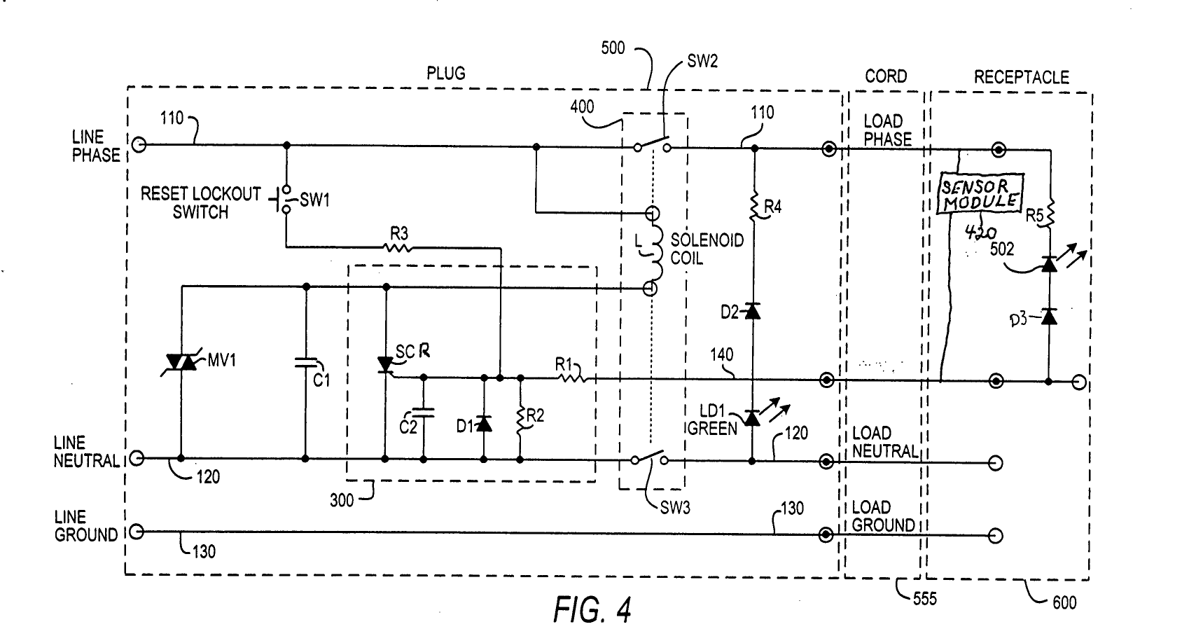

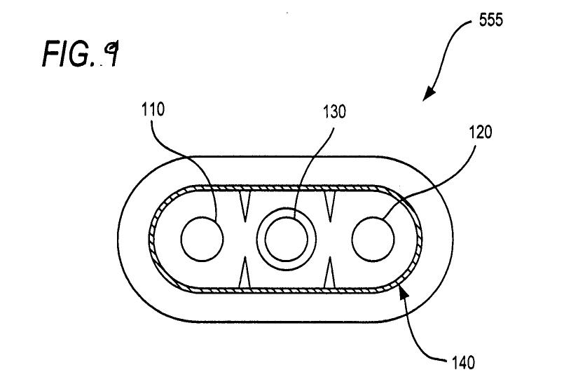

Referring to FIG. 4, there is illustrated a schematic of an LCDI circuit located within a plug of an extension cord coupled to a sensor module 420 in the extension cord receptacle for detecting a non-electrical condition such as smoke, high heat, etc. with a current of nominal value such as a leakage current in the extension cord receptacle. The circuit of FIG. 4 located within the plug is similar to the circuit of FIG. 2 where the sense conductors in Detector 200 has been eliminated and there is added an extension cord 555 which includes a wire or a shield 140 (see FIG. 9) and which connects plug 500 to receptacle 600 and is connected to a sense module 430 for detecting a non-electrical abnormal condition. Thus, when conductor 140 is a shield, the phase conductor 110, the neutral conductor 120 and the ground conductor 130 are located within the shield. The generation of a small nominal current from the sensor module 420 upon detecting an abnormal non-electrical condition is applied to the conductor 140 which, through the action of control circuit 300 and interrupter circuit 400 of the LCDI circuit in the plug 500 operates to interrupt the flow of current through the plug to the extension cord 555. If desired, an LED 502 which may emit a green light can be located within the receptacle to verify the conductivity of the conductor 140. Current flows through the LED 502, diode D3 and resistor R5, illuminating the LED while the SCR is incapable of firing. During the positive half cycle, diode D3 blocks the current so that the SCR does not fire inadvertently. The conductor 140 integrity indicator 502 can be used as a replacement for the load power indicator LDI since it is only illuminated when there is power to the load.

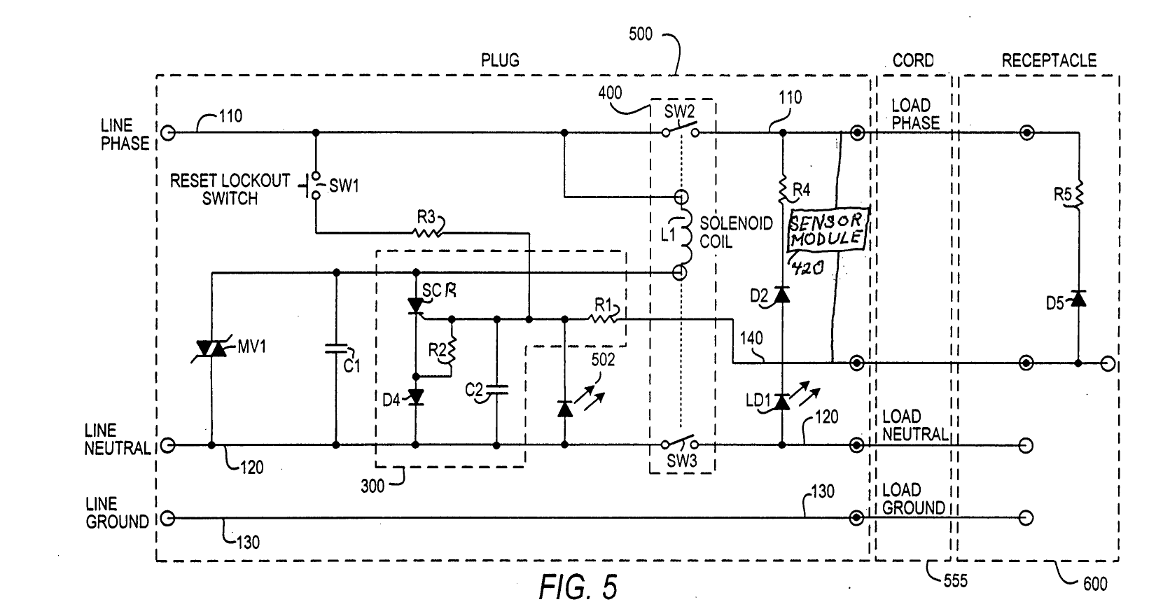

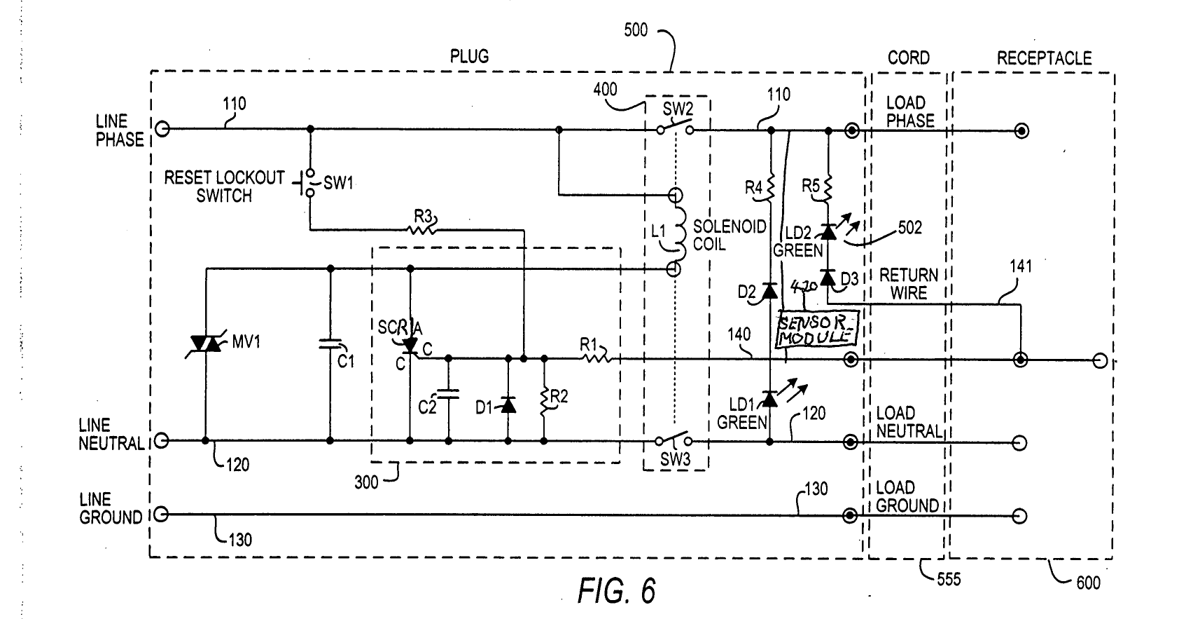

FIGS. 5 and 6 show alternative embodiments of the conductor 140 integrity indicator where the indicating LED is located in the plug of the extension cord. The operation of the LCDI circuit and the conductor 140 integrity indicator in both FIGS. 5 and 6 is similar to that of FIG. 4 and, therefore, is not repeated here. In each instance, current flows through the shield integrity indicator 502 during the negative half cycle of the AC signal and is blocked during the positive half cycle. The circuit of FIG. 6 utilizes a return wire 141 which can be insulated from conductor 140 throughout the length of the power cord 555.

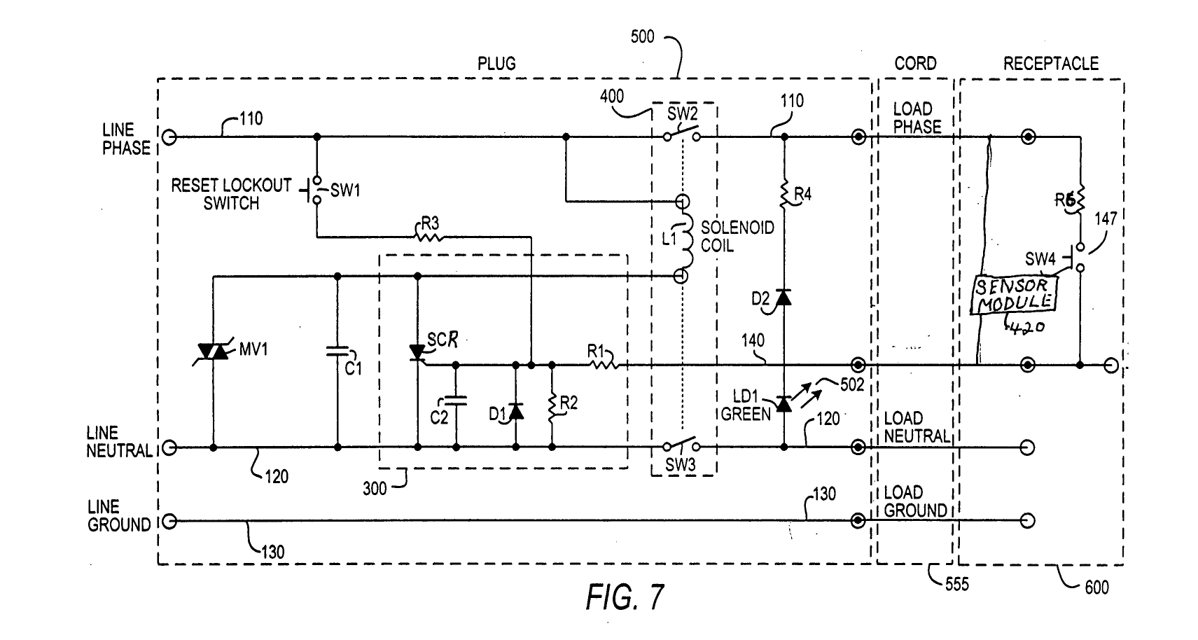

A test button can be provided to test the continuity of conductor 140 and to verify proper circuit operation. Referring to FIG. 7, a test circuit comprising a resistor R6 in series with a normally open switch 147 is connected between the load phase conductor 110 and the conductor 140. Closing the switch creates leakage current from load phase 110 through the conductor 140 to the detecting circuit 500. The AC source will be operatively disconnected from the extension cord and the load indicator 502 will be extinguished. If the load indicator 502 remains lit, this shows that the test has failed. FIG. 7 is a schematic of an LCDI circuit located in the plug of an extension cord having a conductor 140 integrity test switch in the extension cord receptacle.

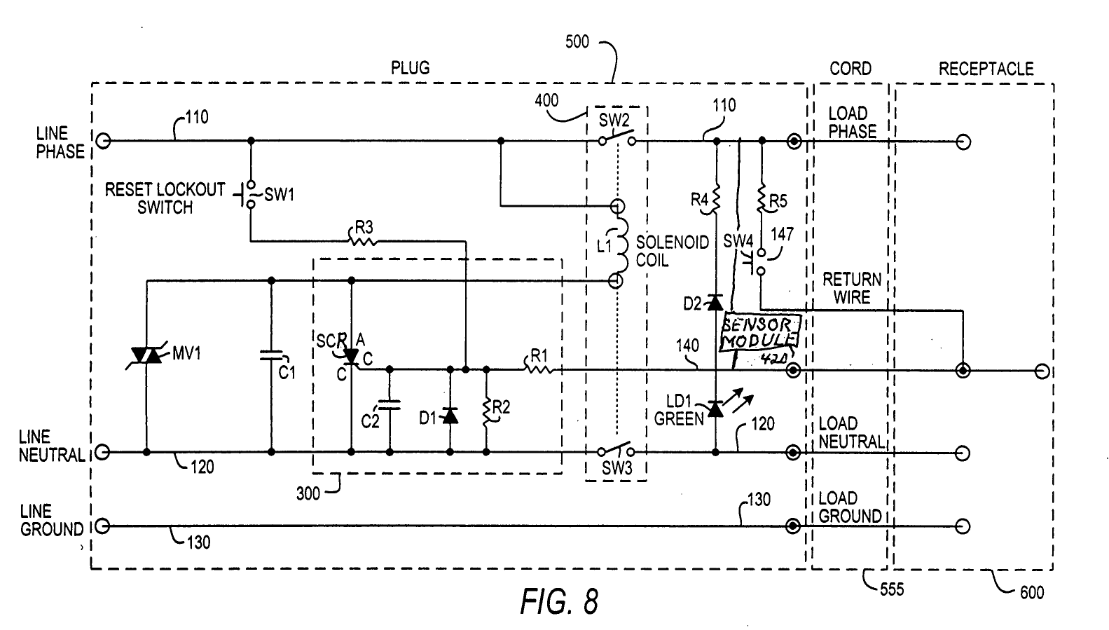

FIG. 8 is a schematic of an LCDI circuit located in the plug of an extension cord having a conductor 140 integrity test switch and a sensor module 420 in the plug. The operation of the circuit of both FIGS. 7 and 8 is similar to that of FIG. 4 and, therefore, in not repeated here. A conductor 140 integrity switch can be used in conjunction with a shield integrity indicator as they work independently of each other. With the circuit of FIG. 8 it is possible to combine the operation of the reset lockout switch and the conductor 140 integrity switch such that the LCDI operation and conductor 140 integrity are tested before the circuit can be reset.

While there have been shown and described and pointed out the fundamental novel features of the invention as applied to the various embodiments, as is presently contemplated for carrying them out, it will be understood that various omissions and substitutions and changes of the form and details of the device illustrated and in its operation may be made by those skilled in the art, without departing from the spirit of the invention.

1. An electrical cord having first and second ends for conducting electricity to an appliance having a phase conductor and a neutral conductor connected at the first end to phase and neutral blades of a plug and adapted to be coupled to an appliance at the second end comprising:
a leakage current detector interrupter coupled to said phase and neutral conductors at said first end of said cord; and
sensor module to detect an abnormal non-electrical condition electrically coupled via a conductor to said leakage current detector interrupter;
wherein said sensor module, upon detecting an abnormal non-electrical condition generates a nominal signal which is fed via said conductor to enable operation of said leakage current detector interrupter to interrupt the flow of electricity to said second end of said cord.

2. The electrical cord of claim 1 further comprising, an integrity indicator coupled to denote if said sensor module is electrically coupled to said leakage current detector interrupter.

3. The electrical cord of claim 2, wherein the integrity indicator is located at the second end of the cord.

4. The electrical cord of claim 3, wherein the integrity indicator is a light.

5. The electrical cord of claim 3, further comprising a switch located at the second end of said cord for testing the integrity of the cord.

6. The electrical cord of claim 5, wherein the switch is used to test for continuity of the conductor between said sensor module and said leakage current detector interrupter.

7. The electrical cord of claim 1 further comprising a receptacle coupled to said second end of said cord.

8. The electrical cord of claim 7, further comprising a sensor module located in the receptacle to activate the leakage current detector interrupter to interrupter the flow of current to the receptacle upon exposure of the sensor module to an abnormal non-electrical condition.

9. The electrical cord of claim 2, wherein said integrity indicator is located in the plug of said cord.

10. The electrical extension cord of claim 9, wherein said integrity indicator is a light.

11. The electrical extension cord of claim 10, further comprising a receptacle coupled to said second end of said cord; and a switch located in said receptacle for testing the integrity of the cord.
